(19) United States
(12) Patent Application Publication
(10) Pub. No.: US 2007/0103658 A1
(43) Pub. Date: May 10, 2007

(54) Lithographic projection device, method an substrate for manufacturing electronic devices, and obtained electronic device

(75) Inventor: Peter Dirksen, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,510

(22) PCT Filed: Dec. 7, 2004
(86) PCT No.: PCT/IB04/52690

§ 371 Date: Jun. 15, 2006

(30) Foreign Application Priority Data
Dec. 22, 2003 (EP) 03104868.9

(51) Int. Cl. G03B 27/42

(52) U.S. Cl. 355/53; 355/67

(57) ABSTRACT

The invention proposes a lithographic projection device such as a wafer stepper for forming a pattern on a substrate or wafer, comprising a(n) (actinic) radiation or light source (2), illumination optics (4) for directing light issuing from said light source onto a mask (6) and projection optics (8) for directing diffracted radiation or light from said mask to the substrate/wafer to be imaged, wherein an optical filter (9) is provided downstream of said projection optics and an imageable substrate (7) having an optical filter (9) on the side to be imaged.

The present invention is related to the technique of lithographic imaging of substrates such as wafers or similar substrates having a radiation sensitive layer thereon for producing integrated circuits and the like. More particularly the present invention is related to optical lithography and refers to a lithographic projection device, a substrate for lithographic imaging, a method for manufacturing electronic devices and electronic devices obtained.

In a specific application an example of a known lithographic projection device is a so-called wafer stepper. Use is commonly made of a substrate coated with a radiation sensitive layer, an embodiment thereof being photoresist.

In this technical field one particular application is related to wafers. In the usual process of imaging a wafer use is made of a wafer stepper comprising a light or radiation source, illumination optics for directing light issuing from said light source to a mask, also called reticle and projection optics for directing light from said mask to the wafer to be imaged, usually having either a positive or a negative type of resist, meaning that either the exposed areas are hardened and the non-exposed areas are washed out or that the areas are weakened and later on washed out by means of for example a development process.

In recent years it has been found, however that the resolution requirements and the sharpness of the image on the wafer and on other substrates do require higher resolutions, in particular in the light of the general aim of providing smaller integrated circuits or other electronic features. The resolution is proportional to λ/NA, wherein λ is the wavelength of the projection beam and NA the numerical aperture of the projection system. The resolution can be increased by increasing the numerical aperture or reducing the wavelength.

From U.S. Pat. No. 5,452,053 several embodiments of so-called wafer steppers are known, all comprising a light or radiation source, illumination optics for directing light issuing from that light source onto a mask and projection optics for directing diffracted light from said mask to the wafer to be imaged, wherein an optical filter is provided either near the reticle plane or included in the illumination optics in order to provide for either a phase shift or an oblique illumination of the mask or reticle. This allows for a substantial increase in resolution since the diffraction pattern of the mask is used rather than the direct optical image thereof. The most common practice intends to decrease the zero-order and to increase high frequency content of the optical image by a filter that blocks certain spatial frequencies, also known as pupil filters. Phase shifting masks, off-axis-illumination and pupil filters are however troublesome to implement. Phase shift masks are relatively expensive and pupil filters require direct access by the user which is not possible in many cases. Moreover, such an optical filter involves strong requirements with respect to structure and dimensions, thus rendering it difficult to obtain an effective filter.

In the light of the above, it is an object of the present invention to provide for a lithographic device and a method having or providing enhanced resolution and improved DOF without showing the shortcomings and drawbacks of the prior art. It is a further object of the present invention to provide a novel substrate, such as a wafer, allowing to be imaged with high resolution without requiring expensive and sophisticated imaging devices.

The above objects are achieved according to the invention by a lithographic projection device, and a lithographic substrate for manufacturing electronic devices according to the independent claims, preferred embodiments being defined in the respective dependent claims. The invention also provides a manufacturing method using the device and or substrate according to the invention, the obtained electronic device being claimed as well.

In particular, the present invention provides a lithographic projection device such as a wafer stepper for forming a pattern on a substrate, such as a wafer, comprising a radiation or light source for emitting actinic radiation, illumination optics for directing radiation or light issuing from said source onto a mask and projection optics for directing diffracted light or radiation from said mask to the substrate or wafer to be imaged, said substrate being sensitive to actinic radiation, wherein an optical filter is provided downstream of said projection optics. The provision of the optical filter remote from the mask or reticle has the advantage that it can be directly accessed by the user. The lithographic projection device may be, among others, a wafer stepper, wafer scanner or an optical projection printer with a programmable mask. The lithographic apparatus may also be an immersion stepper; in this case projection optics may include an immersion lens. Typical wavelengths that can be used with the invention include 365, 248, 193, 157 nm; the numerical aperture may be 0.6-0.90 for a dry system. For an immersion tool NA may increase to 1.3 or even higher.

Preferably the optical filter is able to decrease the zero-order diffracted light. The decrease of the zero-order can be a full suppression or in specific applications a reduction by a factor of 2-3 only. In this case the effect will be an enhancement of the process latitude including focus and dose or a sharpening effect rather than a resolution increase. The filter should accordingly be configured to allow transmission of first and/or higher order diffracted radiation.

According to a preferred embodiment the optical filter is responsive to the angle of incidence of the radiation or light. Simple optical filters can accordingly be used downstream of the projection optics. In this context it is to be noted that the degree of freedom in angular positioning is far more easy to handle in a downstream position of the projection optics, since the optical filter can be provided separately and with a wide range of possible incidence angles, since the angle of the light diffracted and passed through the projection optics can be clearly larger, i.e. up to four times as large. The NA scales with the magnification. Usually steppers or scanners have a 4× reduction, thus the NA is indeed 4 times larger. However, larger reduction factors are also possible. For example 5× or even 10×. Maskless tools may use a 200× demagnification as compared to close to the reticle or mask.

Preferably said optical filter is comprised of an interferometer, in particular a Fabry-Perot interferometer. The term interferometer as used herein and in the claims is not intended to be restricted to a tool made of bulk quartz elements like mirrors only, but is rather intended to cover any interference structure or coating, interference stack, multilayer film, etc, such a stack of layers having a thickness of typically ½ or ¼λ. The use of an interferometer and in particular of a Fabry-Perot interferometer is a most efficient and economic way to provide an optical filter satisfying the needs as required to decrease the zero-order and increase the high-frequency content of the optical image in a place downstream of the projection optics. Care should be taken to provide for definite substantially parallel interfaces having a mutual optical distance (=geometrical distance*index of refraction) suited for suppressing the zero order diffraction by destructive interference. The refractive index difference at the interfaces should be relatively large, e.g. larger than 0.5, to increase the interference efficiency which results in higher contrast.

According to a preferred embodiment said interferometer is comprised of dielectric coatings, in particular comprising SiO₂ and/or AquaTAR. As known in the art of interferometers, a Fabry-Perot interferometer for instance comprises two mirrors that are spaced a certain distance apart. In the preferred embodiment the mirrors are dielectric coatings. The indicated materials are usually available for an exposure wavelength of λ=193 nm and can be deposited in a sufficiently controlled manner, resulting in the required structure and mutual parallelity.

The inventive lithographic projection device, e.g. a wafer stepper, may be configured such that the optical filter is associated with the substrate to be imaged, in particular unitarily formed with a photoresist layer of said wafer to be imaged. In such an embodiment it is possible to position the wafer to be imaged with the associated optical filter in such a manner as to allow transmission of diffracted light having a specific order other than the zero-order.

According to a preferred embodiment the projection optics is demagnifying. Thus the difference between the zero-order diffraction and the higher-order diffraction downstream of the projection optics is larger than that upstream of the projection optics. Due to this effect the requirements for a filter according to the invention are less critical than those for a filter of the known lithographic tool. The invention thus allows for the realization of such an optical filter in a more reliable way, since the diffraction pattern as such is first fed through the projection optics, thus providing for an angle of incidence that is clearly larger than that at a location close to the reticle. Accordingly, such a filter with the desired properties can be realized much more easily. In full contrast to the prior art, where the filter is always provided close to the reticle or mask, and in any event upstream of the projection optics, the present invention allows in a most innovative manner to provide for high resolution imaging without the necessity of high-grade optical filters. An advantage of the inventive concept is that very sharp images with very high resolution can be obtained since it is of course also possible to use a high-grade optical filter downstream of the projection optics.

In summary, the invention thus proposes an innovative lithographic projection device, such as a wafer stepper, that surprisingly can be readily used with an optical filter, wherein the optical filter has fewer requirements by positioning the optical filter downstream of the projection optics as a totally novel approach, since it is contrary to the teachings of the prior art. In a most convenient way the optical filter can be formed as a resolution enhancing stack associated with, or unitarily formed with, the wafer to be imaged.

The invention accordingly also proposes a substrate, such as a wafer, having an optical filter on the side to be imaged. Although multilayer wafers are already known in the art, none of the known multilayer wafers is constructed such that the multilayer structure could provide for the function of an optical filter. The refractive index difference at the interfaces should be relatively large, e.g. larger than 0.5, to increase the interference efficiency which results in higher contrast.

According to a preferred embodiment the optical filter is comprised of an interferometer, in particular a Fabry-Perot interferometer. The use of an interferometer as an optical filter represents a most convenient and inexpensive configuration. Once again it is to be understood that the term interferometer is to be considered more as an interference device and should therefore not be restricted to an optical part, as often referred to in physical standard books. In general the basic theory of an interferometer is given such that the transmission

$$T = \frac{1}{1 + F {sin}^{2} δ}$$

with F being the Finesse:

$$F = \frac{4 R}{{( 1 - R )}^{2}}$$

R being the reflectance and δ=(2πdcosθ)/λ where n is the refractive index, d the resist thickness, θ the angle of incidence and λ the exposure wavelength. In general it is desirable to match the angle of maximum transmission to the angle of the first diffraction orders. Accordingly, to create a sharp filter it is desirable to have a high finesse. Thus it is preferred to create a large reflectance and select materials without absorbance. As an example, a reflectance R=0.8 suppresses the zero-order by a factor of 100 with respect to the first order.

The optimal thickness is

$${d}_{opt} = \frac{( 2 m + 1 ) λ}{4 n} m = 0 , 1 , 2 , …$$

The angle of maximum transmission for m=1 is cos(θ)=⅔, corresponding to a numerical aperture of 0.75. Of course it is possible to change this angle by changing the thickness.

According to a preferred embodiment the imageable substrate or wafer comprises an interferometer comprised of dielectric coatings comprising, in particular, SiO₂ and or AquaTAR. (brand name of Clariant) The use of those materials to provide dielectric coatings serving as mirrors for the interferometer is based on the fact that they (?) are regularly available products known in the wafer technology and are easily handled in order to obtain the required planarity, (?) thicknesses and other characteristics, as required.

For certain applications it is necessary to suppress the zero-order by a factor of 2-3 only. This will result in an enhancement of the process latitude focus and dose or a sharpening effect, thus providing for an increase in DOF, rather than a resolution increase or doubling.

A most simple way to realize such an optical filter in the form of a resolution enhancement stack is to provide a resist, n=1.8, between a bottom layer of 150 nm Sio₂, n=1.5, and a top layer of 90 nm AquaTAR, n=1.5. Both materials are regularly available for an exposure wavelength λ=193 nm, and their thickness can be controlled sufficiently accurately by standard processing.

The substrate may be a plate of a material, for example silicon. The main processing steps can include : coating with a radiation sensitive layer, exposing, developing, etching, depositing. The steps essential for the inventive method are the imaging step using an optical filter downstream of the projection optics and the following developing step. The optical filter may be positioned above and separately from the substrate, thus allowing to use standard substrates and multiple use of the optical filter. Alternatively it is possible to provide the optical filter on top of the radiation sensitive layer, e.g. as a thin film or stack of layers, or the optical filter may include the photoresist itself, preferably with a resist thickness of less than λ/4, in order to avoid problems related to standing waves in the resist. As a further alternative it would also be possible to provide the filter below the resist.

Lithographic imaging may be used to manufacture various devices such as magnetic heads, LCD displays, etc.

Further characteristics and advantages of the invention will become apparent upon reading the description of actually preferred embodiments being given in a non-limiting way and as pure examples taking reference to the accompanying drawings, wherein:

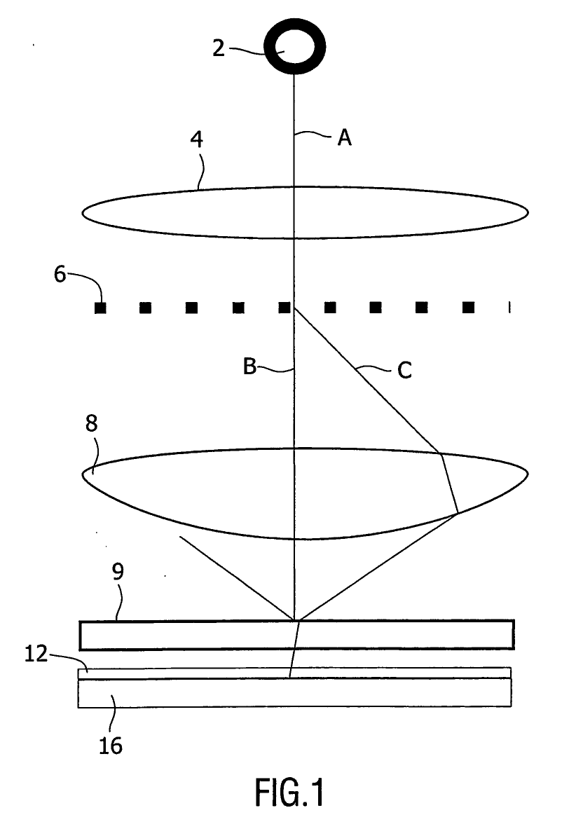

FIG. 1 shows a schematic view of a wafer stepper as an example of an lithographic projection device according to a first embodiment of the present invention.

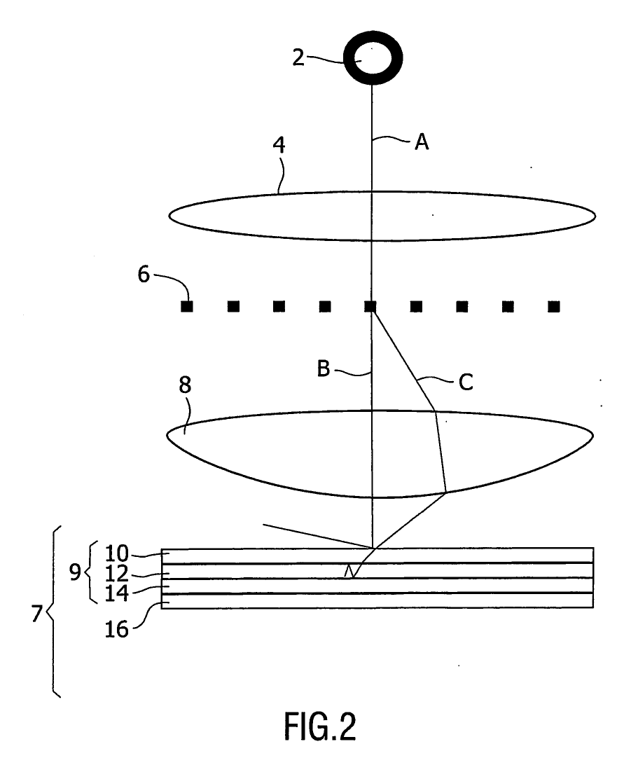

FIG. 2 shows an alternative embodiment of a wafer stepper as a further example of a lithographic projection device according to the present invention, making use of a substrate in the form of a wafer having an optical filter provided on the side to be imaged, according to the present invention.

As depicted in FIG. 1, the wafer stepper for forming a pattern on a wafer comprises a light source 2. The light source emits light, indicated by line A, that will be passed through an illumination optics for directing the light issuing from the light source onto a mask 6. It should be understood that although in the representation the illumination optics 4 is simply shown as a single lens, said illumination optics could furthermore include a fly's eye lens and various other elements for focusing the incoming radiation. The mask or reticle 6 includes, as is well known in the art, a suitable pattern, for instance provided by chromium applied to a quartz substrate providing for a suitable diffraction pattern. The diffraction pattern includes a plurality of diffraction orders. In the drawings only the zero-order is indicated by the line with reference sign B and the first order diffraction is indicated by a line with reference sign C. It is to be noted that the drawings are only systematic drawings and do not truly reflect dimensions, realistic diffraction or optical paths in the respective optics and are merely intended for explanatory purposes. Nevertheless, both of the diffraction orders, i.e. the zero-order and the first order, are fed to a projection optics, again shown simplified as a single lens 8; the person skilled in the art will clearly realize that the projection optics could be more complex.

Both of the diffraction orders are passed through the projection optics 8 and arrive at an optical filter 9 which is configured such that it suppresses the transmission of the zero-order diffracted light relative to the transmission of the first order diffracted light. Accordingly, the zero-order diffracted light is fully reflected and the first diffraction order forms the image in a photoresist layer 12 provided on the wafer 16. The optical filter 9 may be any suitable filter, a pupil filter or any other well known device allowing either to block or to reduce certain spatial frequencies.

FIG. 2 shows another preferred embodiment of the lithographic projection device in the form of a wafer stepper. The configuration from the light source 2 up to the projection optics 8 is similar to the construction as used in the first embodiment and, accordingly, for the sake of a short description, corresponding elements bearing corresponding reference signs will not be described in detail again. Nevertheless it is indicated once again that the shown and described elements are merely for explanatory purposes and could be replaced by more complex systems.

In the embodiment shown in FIG. 2, the optical filter 9 is formed unitarily with the wafer 16 to be imaged and is composed—in the form of a resolution enhancement stack—of a top layer of 90 nm AquaTAR having a refractive index n=1.5 provided above a layer of photoresist 12 provided, at its lower side, with a bottom layer of 150 nm SiO₂ having a refractive index n=1.5. The resist layer itself is provided in a thickness of λ/4˜50 nm and has a refractive index n=1.8. Accordingly, this multilayer structure forms a Fabry-Perot interferometer serving as an optical filter and being provided downstream of the projection optics when provided on any wafer stepper.

Accordingly, FIG. 2 also shows a preferred embodiment of an inventive imageable substrate or wafer having an optical filter on the side to be imaged, formed by the aforementioned Fabry-Perot interferometer, which, in the illustrated example, is constructed by means of a multilayer structure having the photoresist layer sandwiched between two dielectric coatings as indicated above. It is to be noted that other materials could be used alternatively, however, it has been found that the above-mentioned materials, having the indicated thicknesses and structure, allow an optical filter to be readily manufactured in a very cost-effective manner.

In the above description of preferred embodiments the term light was used as an example of actinic radiation without any intention of restricting the invention accordingly. The person skilled in the art will realize that specific parameters related to wavelength will have to be adapted when other actinic radiation is used.

Although the present invention has been described above with reference to preferred embodiments, it should be considered that various modifications are possible as the scope of protection requested is defined only by the appended claims. The major feature of the wafer stepper according to the invention is to provide an optical filter downstream of the projection optics, preferably associated with or unitarily formed with the substrate or wafer to be imaged, for instance in the form of a Fabry-Perot interferometer constructed on top of the resist or the photoresist layer sandwiched between dielectric layers. As regards the inventive imageable wafer it is clear that various alternative materials could be used as well as additional layers for providing specific optical or process related characteristics or for giving selective exposure as it is well known in the art of wafer imaging.

1. A lithographic projection device for forming a pattern on a substrate, comprising a radiation source (2) for emitting actinic radiation, illumination optics (4) for directing radiation issuing from said radiation source onto a mask (6) and projection optics (8) for directing diffracted radiation from said mask to the substrate to be imaged, said substrate being sensitive to actinic radiation, wherein an optical filter (9) is provided downstream of said projection optics.

2. The lithographic projection device according to claim 1, wherein said optical filter (9) is able to decrease the zero-order diffracted radiation while allowing transmission of first and/or higher diffraction orders.

3. The lithographic projection device according to claim 1, wherein said optical filter (9) is responsive to the angle of incident radiation.

4. The lithographic projection device according to claim 1, wherein said optical filter (9) comprises an interferometer, in particular a Fabry-Perot interferometer.

5. The lithographic projection device according to claim 4, wherein the interferometer comprises a dielectric coating (10, 14), in particular comprising SiO₂ and/or AquaTAR.

6. The lithographic projection device according to claim 1, wherein said optical filter (9) is associated with the substrate (7) to be imaged, in particular unitarily formed with a photoresist layer (12) of said substrate to be imaged.

7. The lithographic projection device according to claim 1, wherein said mask is a programmable mask.

8. The lithographic projection device according to claim 1, wherein said projection optics are demagnifying projection optics.

9. An imageable substrate (7) comprising an optical filter (9) on the side to be imaged by actinic radiation having a wavelength λ, said side having a photoresist.

10. The imageable substrate according to claim 9, wherein said optical filter is an optical filter (9) capable of decreasing the zero-order diffracted radiation while allowing transmission of first and/or higher diffraction orders.

11. The imageable substrate according to claim 9, wherein said optical filter (9) is responsive to the inclination angle of incident radiation.

12. The imageable substrate according to claim 9, wherein said optical filter (9) comprises an interferometer, in particular a Fabry-Perot interferometer.

13. The imageable substrate according to claim 12, wherein the interferometer comprises a dielectric coating (10, 14), in particular comprising SiO₂ and/or AquaTAR.

14. The imageable substrate according to claim 9, wherein the optical filter, in particular said interferometer, is a transparent layer or stack of layers on top of said photoresist.

15. The imageable substrate according to claim 9, wherein the optical filter, in particular said interferometer, comprises said photoresist layer (12), sandwiched between dielectric coatings (10, 14), in particular a photoresist layer (12) sandwiched between a bottom layer (14) of SiO₂ and a top layer (10) of AquaTAR, more particularly a λ/4˜50 nm photoresist layer sandwiched between a 150 nm bottom layer of SiO₂ and a 90 nm top layer of AquaTAR.

16. A manufacturing method for electronic devices, comprising the steps of:
imaging a substrate; and
developing said imaged substrate;
wherein a lithographic projection device according to claim 1.
